(19) United States
(12) Patent Application Publication
(10) Pub. No.: US 2019/0272517 A1
(43) Pub. Date: Sep. 5, 2019

(54) SYSTEM AND METHOD FOR PROCESSING RETAIL PURCHASES AT A POINT-OF-SALE POS SYSTEM USING A PERSONAL MOBILE TERMINAL

(71) Applicant: XHOCKWARE S.A., Porto (PT)

(72) Inventor: Joao PAULO RODRIGUES, Porto (PT)

(21) Appl. No.: 16/416,835

(22) Filed: May 20, 2019

Related U.S. Application Data
(63) Continuation of application No. 14/767,823, filed on Aug. 13, 2015, now abandoned.

(30) Foreign Application Priority Data
Feb. 19, 2013 (PT) 106791

(51) Int. Cl. G06Q 20/20; G07G 1/00; G06Q 20/32; G07G 1/14

(52) U.S. Cl. CPC G06Q 20/202; G07G 1/0072; G06Q 20/208; G07G 1/0081; G07G 1/14; G06Q 20/3276

(57) ABSTRACT

System and method for processing retail purchases at a point-of-sale POS system, by a user carrying a personal mobile terminal, said mobile terminal having a network data connection and a barcode reader for relaxing, by the user, of the barcodes of the products to be purchased, said system comprising a computer server for receiving the barcodes read by said mobile terminal through said network data connection; an electronic controller for receiving the barcodes received by said computer server through a suitable data link; a data connection between said controller and said POS; wherein said controller is arranged to send to the POS system through said data connection the received barcodes to be processed by said POS system as a retail purchase by said user.

### TECHNICAL FIELD

The present disclosure relates to the processing retail purchases at a point-of-sale POS system by a user carrying a personal mobile terminal.

### BACKGROUND ART

Prior art systems (e.g. KR20070014380A) rely on mobile devices to handle the checkout procedures, addressing all stages of the process, including product scanning, billing and invoicing. These are normally called Mobile or Portable checkout, aimed at providing additional checkouts when high waiting times are expected or verified, or when flexibility of checkout location is required.

Unlike the present invention, these systems are in fact a POS system, or at least incorporate the most important features from POS, and operate from a logical point-of-view, as standard POS, integrating with the infrastructure in a client-server based architecture.

These systems communicate directly to a store server or a retailer main server, over an established communication channel. These solutions are retailer specific as they communicate directly with the existing infrastructures and impose substantial adaptation and configuration project costs and duration.

These facts are disclosed in order to illustrate the technical problem addressed by the claimed invention.

### SUMMARY

It is described a method of operating a system for processing retail purchases at a point-of-sale POS system, by a user carrying a personal mobile terminal, said mobile terminal having a network data connection and a barcode reader for reading, by the user, of the barcodes of the products to be purchased, said method comprising the steps of:

the mobile terminal reading the barcodes of the products to be purchased;
the mobile terminal sending the read barcodes to a computer server through said network data connection;
said computer server sending the received barcodes to an electronic controller through a suitable data link;
said controller sending, through a data connection to the POS system, the received barcodes to be processed by said POS system as a retail purchase by said user.

It is also described a method of operating a system for processing retail purchases at a point-of-sale POS system, by a user carrying a personal mobile terminal, said mobile terminal having a network data connection and a barcode reader for reading, by the user, of the barcodes of the products to be purchased, said method comprising the steps of:

the mobile terminal reading the barcodes of the products to be purchased;
the mobile terminal sending the read barcodes to a computer server through said network data connection;
said computer server sending the received barcodes to be stored by an in-store POS server through a suitable data link;
said POS system retrieving the received barcodes from said in-store POS server to be processed by said POS system as a retail purchase by said user.

An embodiment further comprises the steps of:

the in-store server generating a unique token code identifying the received barcodes;
the in-store server transmitting said token code through said computer server and said mobile terminal to the user,
such that said user may supply the POS system operator with said token code,
and such that said POS system operator may supply said token code to the POS system;
the POS system using said token code for retrieving the received barcodes from said in-store server to be processed by said POS system as a retail purchase by said user.

An embodiment further comprises the steps of:

the in-store server generating a unique token code identifying the received barcodes;
the in-store server transmitting said token code to said controller,
the controller sending the token code to the POS system;
the POS system using said token code for retrieving the received barcodes from said in-store server to be processed by said POS system as a retail purchase by said user.

An embodiment further comprises the steps of:

said computer server sending, to the electronic controller, information on the products to be purchased for auditing purposes based on the received barcodes by said computer server;
said controller displaying said audit information about the products to be purchased and only proceeding with the retail purchase process if human confirmation of said audit information is received.

An embodiment further comprises the steps of:

said computer server sending, to the electronic controller, information on the products to be purchased for automatic verification purposes based on the received barcodes by said computer server, in particular the weight of the products corresponding to said barcodes;
said controller automatically verifying said automatic verification information about the products to be purchased, in particular by weighing the products to be purchased,
and only proceeding with the retail purchase process if automatic confirmation of said verification information is obtained.

It is also described a non-transitory storage media including program instructions for implementing a system for processing retail purchases at a point-of-sale POS system, the program instructions including instructions executable to carry out any of the previously mentioned methods.

It is also described a system for processing retail purchases at a point-of-sale POS system, by a user carrying a personal mobile terminal, said mobile terminal having a network data connection and a barcode reader for reading, by the user, of the barcodes of the products to be purchased, said system comprising:

a computer server for receiving the barcodes read by said mobile terminal through said network data connection;
an electronic controller for receiving the barcodes received by said computer server through a suitable data link;
a data connection between said controller and said POS;
wherein said controller is arranged to send to the POS system through said data connection the received barcodes to be processed by said POS system as a retail purchase by said user.

In an embodiment, said data connection between the controller and the POS system is a keyboard or barcode scanner connection emulated by said controller.

An embodiment comprises a plurality of said controllers and said data connections, wherein one controller is connected by a data connection to one and only one POS system, and wherein the mobile terminal is configured to identify the specific controller and respective POS system by scanning a barcode or other visual representation suitable for identification of a specific controller.

An embodiment comprises a weighing scale for weighing the products to be purchased and any carrying container of said products, said weighing scale being connected to the controller.

In an embodiment, the controller is configured to verify if the weight output by the weighing scale is lower than the total of:

the weight of products to be purchased identified by the received barcodes, plus
the weight of the empty carrying container or containers, plus
the weight of a predetermined tolerance,
in order to validate said retail purchase.

In an embodiment, the controller is configured to trigger a warning sign and halt the processing of the retail purchase if a container is not detected at the weighing scale or if the measured weight is outside by a predetermined tolerance of the weight of products to be purchased identified by the received barcodes, plus the weight of the empty carrying container or containers.

In an embodiment, the barcodes received by the controller from the server are sent by the server in a batch and the barcodes sent by the controller to the POS are sent in a batch, both said batches consisting of the totality of the barcodes of the products being purchased in said retail purchase.

In an embodiment, the controller comprises a human input and output interface for an operator and is arranged to display auditing information and to request a positive auditing confirmation by said operator in order to send the received barcodes to the POS system.

In an embodiment, said computer server and said mobile terminal have been mutually authorised and associated previous to the retail purchase to be processed and/or said POS system and mobile terminal are not configured to be mutually authorised and associated.

In an embodiment, the mobile terminal is a mobile phone or tablet comprising non-transitory storage media with a program for implementing said mobile terminal, and wherein the electronic controller comprises non-transitory storage media with a program for implementing said electronic controller, and wherein the server comprises non-transitory storage media with a program for implementing said server, wherein the instructions of said programs include instructions executable to carry out any of the previously mentioned methods.

### DISCLOSURE OF THE INVENTION

It is an object of the disclosure to optimize the process of processing and payment of all the products (checkout) involved in a purchase at, for instance, Super/Hypermarkets.

The present disclosure describes the process of scanning the barcodes of products, EAN, UPC, Databar, or others alike, as well as the process of validation of the items purchased, and subsequent upload to (integration with) the external Billing, Point of Sale or equivalent system.

With the present disclosure, it is possible to cut down to a few seconds the complete process of product handling (scanning) and payment, with a security degree equivalent to that of a operator manned checkout.

The disclosure is characterised in particular by the way on how it integrates with the existing Billing or Point of Sale systems, and by the purchased products validation system. The present disclosure intends to be an add-on to existing Billing/Point of sale systems, installed at every checkout, allowing for checkout optimization, and if intended, full automatic unattended checkout, through avoiding the requirement for an operator at every checkout.

Presently, product processing at retail stores or warehouses is done considering that the item is picked-up from its storage space, by the client or an employee, and is later processed at checkout, by an operator, that scans the barcode of every item, and completes the sale, through payment and/or printing the correspondent bill of sale.

This is an costly process, as it requires that every item is taken from the shopping cart or container on which they are transported, requiring that every barcode is scanned, prior of placing them back in the shopping cart or transport container.

The time required for processing the items is directly proportional to the number of items.

There are systems available that allow for the scanning of the barcode to occur when the item is picked up from their storage space, allowing that, at checkout, it is no longer necessary to scan the barcode of every item, so that only the payment remains to conclude the transaction.

When this process in conducted by an employee, theft is not considered as possible or relevant, but when the customer is solely responsible for scanning the products, then the risk of possible fraud attempt becomes a relevant factor by the loses and costs it may reach.

Studies show that the theft rate at self-checkout systems, where the customer is responsible for checkout, is 5× higher when compared to the alternative of standard checkout at operator manned checkout. Nevertheless, the large majority of self-checkout systems use random audit as the only mechanism for verification and control.

The presented disclosure aims at allowing for faster checkout of products, assuring that the barcode of each item does not need to be scanned individually at checkout, but when they are picked up from storage, while at the same time assures that the items listed in the processed items manifest are in fact the ones contained in the product container (Shopping Cart, Basket, Bag or Box).

The disclosed system comprises three components;

1—TERMINAL: A system for scanning barcodes, implemented as a computer application, capable of running on customer's equipment (Smartphone or Tablet), or on Retail Store's or Warehouse's equipment, available for either or both Customers and Employees.

2—CONTROLLER: A control system, composed by a central processing unit, capable of reading the items uploaded by component 1. the TERMINAL, and subsequent uploading of the items to the external Billing or Point of Sale system. This control system can also validate if the items listed on the manifest, match with the items contained in the Product Container (Shopping Cart, Basket, Bag, Box, etc.), by using component 3, the SCALE.

3—SCALE: A pressure sensors system that will weight the full set, composed by the Product Container (Shopping Cart, Basket, Bag, Box, . . . ) and all the products/items contained within.

Consider an embodiment of the disclosure of usage for shopping and checkout of a product filled shopping cart, at a Hypermarket.

To use the system, the shopper will use on his/her smartphone the application made available for this purpose. The same objective can be achieved by using a Retail Store provided equipment.

The shopper will do his shopping as usual, taking the products from the shelves, making sure to scan the barcode of the products, using his smartphone, before placing them in the Shopping Cart. The barcodes are scanned through image analysis and recognition, of the image captured by the smartphone's camera.

Throughout the shopping process, the smartphones keeps an updated list (manifest) of the items contained in the shopping cart.

When the shopper finishes the shopping process, he walks to the checkout area to pay for his items.

He places the shopping cart, over the identified area on the floor, where the pressure sensors system (SCALE) is located, and scans the Barcode or 2D Code (QRCode) presented at the checkout counter to proceed with the checkout and validation.

The system uploads the item list (manifest) from the smartphone (TERMINAL) to the central processing unit (CONTROLLER), and weights the shopping cart and all the items contained within, using the pressure sensor system component (SCALE).

Only after determining that the effective weighted value is lower than the sum of the Empty Shopping Cart plus the Items plus the defined tolerance, the system uploads to the external Billing or Point of Sale system the items, as if they were scanned individually by the Checkout operator.

After successful validation of the full amount of the items contained within the transport container, the controller uploads the each item to the billing or Point of Sale Systems, by emulating the scan of the barcodes, as if it were manually scanned by the operator using the barcode scanner integrated with the Billing or Point of Sale System.

This mechanism, considering the different connection options (USB, Serial, Keyboard), makes it therefore possible to interconnect this system with any existing external Billing or Point of Sale System, as long as this is capable of being operated by keyboard and/or Barcode Scanner.

The controller can be connected to the external Billing or Point of Sale system through different connections (USB+Keyboard, Serial+Keyboard), for the purpose of simultaneously emulating the Keyboard and the Barcode Scanner, allowing the system to automate/emulate the keystrokes on the keyboard, that the operator would input when doing a normal checkout.

Payment is handled through any conventional payment and billing mechanism already available by the Retailer.

By communicating the purchase data—which comprises the purchase barcodes—through the POS device that is located at the user checkout position, and not to a central billing server of the retailer like other prior art systems, all the existing data validations and procedures of the billing and processing system are kept and do not require any adaptation.

POS systems, like the presently installed in retail locations, are thus able to receive purchase data—which comprises the purchase barcodes—from a mobile barcode reader without requiring any hardware or software adaptation.

Prior art retail systems receive purchase date from mobile phones used for user barcode reading at a central server which then send confirmation data to the POS, The actual detailed barcode data does not normally reach the POS or, if it does reach the POS, it flows in the reverse direction (server to POS) than in the present disclosure (POS to server), only for confirmation purposes and not actual purchase processing.

The present disclosure aims at facilitating the transfer of barcode data from a personal mobile device for reading barcodes, e.g. a suitable application running on a personal mobile phone, to a standard POS which was not previously adapted to receive barcode data from such a personal mobile barcode reader.

It will be appreciated that when using a personal device, i.e. a device that is not the property of the retail store but within the IT security ambit of the user of the device, direct communications from a personal device to a standard POS device create communication issues in terms of system security, automations, permissions. Also, difficulties arise in terms of practicality and reliability like issues in pairing both devices, for example Bluetooth pairing problems, infrared line of sight restrictions, Wi-Fi ad-hoc connection issues. By communicating from the personal device to the POS through the disclosed system, a preauthorised connection can be quickly established.

Even if, at first sight, it could be seen as disadvantageous sending data through a remote server from a personal mobile device to the POS which is located right next to the user, in fact it is a superiorly secure and practical setup.

Some POS systems are able to process a barcode file or data transmission if a suitable format is used and an adequate interface is provided. In this case, according to an alternative embodiment of the disclosure, it is not required to use a controller emulating barcode scans to the POS. Nevertheless, according to the disclosure, the barcode data still goes through the normal billing process from the POS to a retailer server. In some embodiments, the disclosed controller may be optionally kept for the other disclosed purposes, like auditing the purchase or displaying purchase confirmation details.

### BRIEF DESCRIPTION OF DRAWINGS

The following figures provide preferred embodiments for illustrating the description and should not be seen as limiting the scope of invention.

FIG. 1: Schematic representation of an embodiment, in particular of its POS/controller/scale configuration.

FIG. 2: Schematic representation of an embodiment, in particular of its scale configuration.

FIG. 3: Schematic representation of an embodiment of the overall system configuration, in particular comprising an emulation connection, for example keyboard emulation, from the checkout controller according to the disclosure and the POS system.

FIG. 4: Schematic representation of an embodiment for the controller being directly connected to the POS for transmitting barcode data, namely by emulating a barcode reader.

FIG. 5: shows an alternative embodiment of the overall system configuration, in particular where the controller according to the disclosure is connected to an in-store server.

FIG. 6: Schematic representation of an embodiment for the controller being connected to an in-store server which makes available barcode data for retrieval by the POS on submission of a token, e.g. short numeric code, by the operator when the token is received through the user mobile application.

FIG. 7: Schematic representation of an embodiment for the disclosed server being connected to an in-store server which makes available barcode data for retrieval by the POS on submission of a token, e.g. short numeric code, by the operator when the token is received through the user mobile application.

FIG. 8: Schematic representation of an embodiment for the controller being connected to an in-store server which makes available barcode data for retrieval by the POS on submission of a token, e.g. short numeric code, by the controller directly to the POS device.

FIG. 9: Schematic representation of an embodiment for the disclosed server being connected to an in-store server which makes available barcode data for retrieval by the POS on submission of a token, e.g. short numeric code, by the controller directly to the POS device.

### DETAILED DESCRIPTION

The central processing unit (controller) is contained within a box, with external connections for power, networking (Ethernet, Wireless Wifi, or other), the SCALE, and the several options for inter-connecting with the external Billing or Point of Sale System (US8, AT/PS2 Keyboard, Serial USART, or others to be implemented). This box can also provide connectors to other external accessories like Customer or employee Displays, GPIO (General Purpose Inputs and Outputs) for external mechanic actuators like automatic gates or indicators (Sound or Visual)

The central processing unit (controller) integrates with the external billing or Point of Sale through one (or more) barcode scanners or keyboard inputs. From the external Billing or Point of Sale point of view, the system presented by this disclosure is just an accessory, an additional barcode scanner.

Given the diversity of options and equipment, it is considered the terminal (mobile equipment were the barcodes are scanned), the computer application that runs on this, and the barcode scanning process to be out of the scope of this disclosure, making only relevant the requirement for maintaining a product list (manifest), and the compatibility to the described uploading mechanism.

Through the terminal, equipment used by the user for scanning the barcode and subsequent management of the product list (manifest) contained in the Transport Container, the user triggers the product validation and uploading of the manifest to the external Billing or Point of Sale System, by scanning a barcode, a 2D code (QRCode), or any other visual representation, suitable of individually identifying the controller on which the checkout should occur. This code can be depicted on different mediums, like images or sticker placed on the checkout counter, or on customer's displays.

After the identification of the controller for checkout, the terminal sends, through the existing network, the product list (manifest) of the items in the transport container (Shopping Cart, Basket, Bag, Box, . . . ).

Through the graphical identification of the controller, it is possible for the terminal to obtain the information necessary to access, through the network, the controller. (IP Address, Access Credentials, . . . ).

At this time, the transport containers, should have already been placed over the scale platform, making it possible for the controller to read the full weight, including: Net Weight of the Transport Container, plus the sum of ail the items within.

If the Transport Container is not placed over the scale, than the controller will emit a warning sign, by sound and/or visual sign, and will halt the process until the situation is resolved.

When the total weight of the transport container, measured by the scale, is higher than the value calculated by the controller, based on the product list (manifest), after adding the tolerance, the controller will warn of the error situation, identifying the fraud attempt, or the existence of foreign products (unaccounted or not referenced in the manifest), so that the user can do the necessary adjustments.

After successful validation of the full amount of the items contained within the transport container, the controller uploads the each item to the billing or Point of Sale Systems, by emulating the scan of the barcodes, as if it were manually scanned by the operator using the barcode scanner integrated with the Billing or Point of Sale System.

This mechanism, considering the different connection options (USB, Serial, Keyboard), makes it therefore possible to interconnect this system with any existing external Billing or Point of Sale System, as long as this is capable of being operated by keyboard and/or Barcode Scanner.

The controller can be connected to the external Billing or Point of Safe system through different connections (USB+Keyboard, Serial+Keyboard), for the purpose of simultaneously emulating the Keyboard and the Barcode Scanner, allowing the system to automate/emulate the keystrokes on the keyboard, that the operator would input when doing a normal checkout.

This mechanism allow for the full or partial automation on a external Billing or Point of Sale system of the billing procedure, through the input of pre-configured keystroke sequences, including but not limited to, the “Start Transaction” until the phase of product scanning, and the completion of the checkout, after all items were read.

The billing procedure is completed by the external Billing or Point of Sale system, without any intervention by the user, with the optional notification of this by GPIO of optional conclusion of the payment procedure.

Actuators can be connected as accessories, through GPIO, connected to gate opening mechanisms, that in conjunction with the data input through the keyboard, allows for total automation of the payment procedure, though converting a conventional checkout counter, on a full unattended self-service checkout.

The controller runs all the computational code that handles all the operations and procedures described before, allowing for parameterization according to the specific functions, depending on the implementation or the external Billing or Point of Sale System.

The scale is composed by a metal platform, to which one or more pressure sensors are attached.

Each of the pressure sensors is connected to a controller that analyses the deflection caused by the weight at each sensor, by reading the electrical variation at each one, and converting these measured electrical values to numerical values, corresponding to the load at each of the sensors.

The scale controller allows that the actual value, calculated by adding the individual loads at each sensor, can be read from external devices, which in this case is the controller.

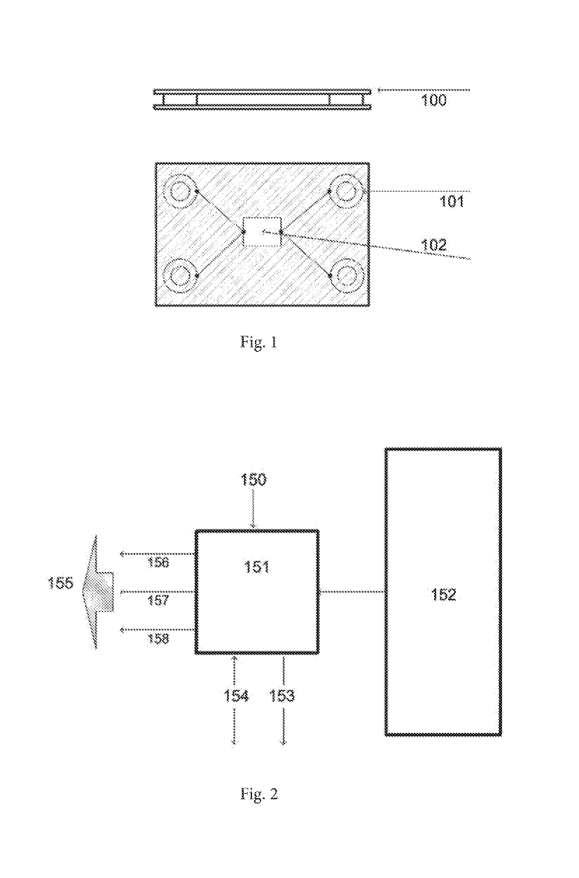

FIG. 1 shows an embodiment, in particular of its POS/controller/scale configuration, comprising a Top Plate -Steel/Stainless steel/Aluminium 100, Load/pressure Sensor 101 and a Controller 102.

FIG. 2 shows an embodiment, in particular of the scale configuration, comprising an Ethernet connection ISO, a check out controller according to the disclosure 151, a weight scale 152, a video display connection 153, a GPIO, general purpose input-output connection 154, a connection to the point of sale (POS)7invoicing system 155, a USB connection 156, a serial data connection 157, and a keyboard (PS2 or AT) connection 158.

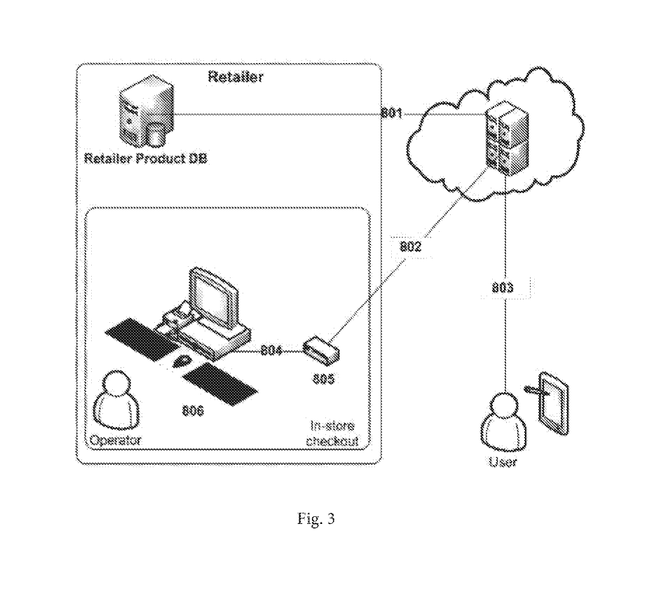

FIG. 3 snows an embodiment, in particular of the overall system configuration comprising a synchronization connection between retailer server (retailer product DO) and main server according to the disclosure 801, a communication link between checkout controller and main server 802, a communication link between User Mobile app to main server 803, an emulation connection, for example keyboard emulation, from checkout controller and POS system 804, a checkout controller according to the disclosure 805 and a POS system 806.

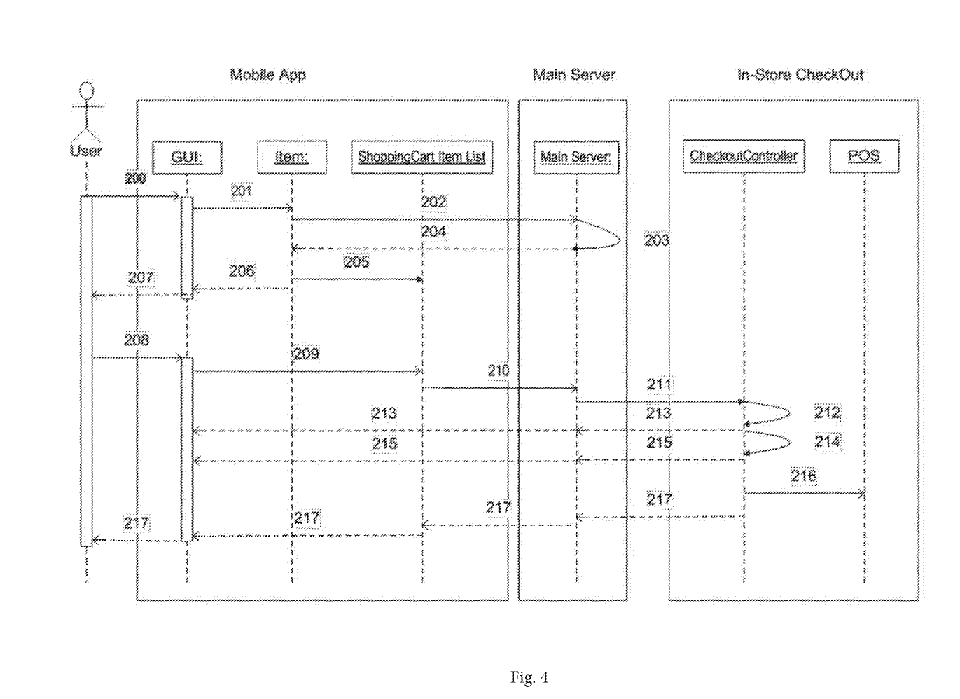

FIG. 4 shows an embodiment for the controller being directly connected to the POS for transmitting barcode data, namely by emulating a barcode reader, comprising the following actions/events by the respective parties as shown in the figure: user opens mobile app to start shopping 200, user reads the barcode from item with the mobile app 201, barcode is sent to Main server to get the product properties 202, main server decodes the barcode, retrieving info from the database 203, item properties are replied by the main server 204, item is added to the shopping cart item list 205, confirmation of item is on the shopping cart list 206, process is complete and user can add more items 207, the User starts the checkout process of the items list 208, command to checkout shopping cart is sent 209, shopping list cart is submitted to the main server 210, shopping list cart is sent by main server to in-store controller 211, automated check of the items on the list 212, automated check ok 213, human audit control of the items 214, human audit of the items is ok 215, checkout controller inserts the shopping cart items in the POS system, namely by emulating a barcode reader 216, operation completed successfully is confirmed to the user 217.

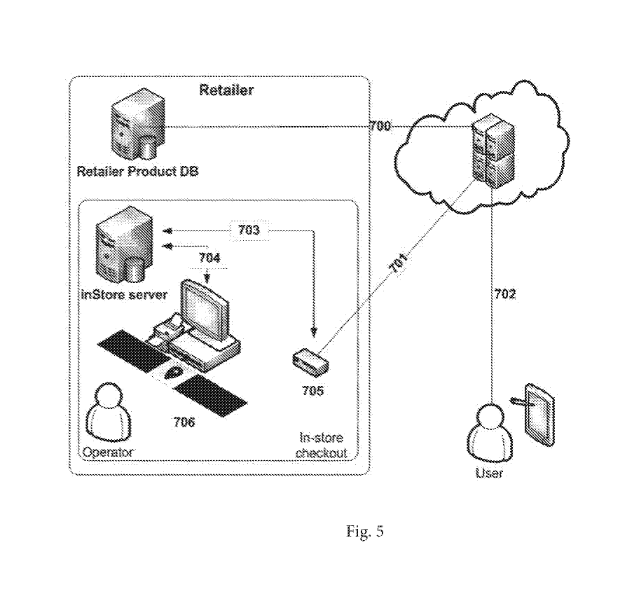

FIG. 5 shows an alternative embodiment of the overall system configuration, in particular where the controller is connected to an in-store server, comprising a synchronization connection between retailer server and main server according to the disclosure 700, a communication link between checkout controller and main server 701, a communication link between User Mobile app and mam server 702, a communication link between checkout controller and in-Store server 703, a communication link between POS system and in-Store server 704, a checkout controller 705 according to the disclosure, a POS system 706.

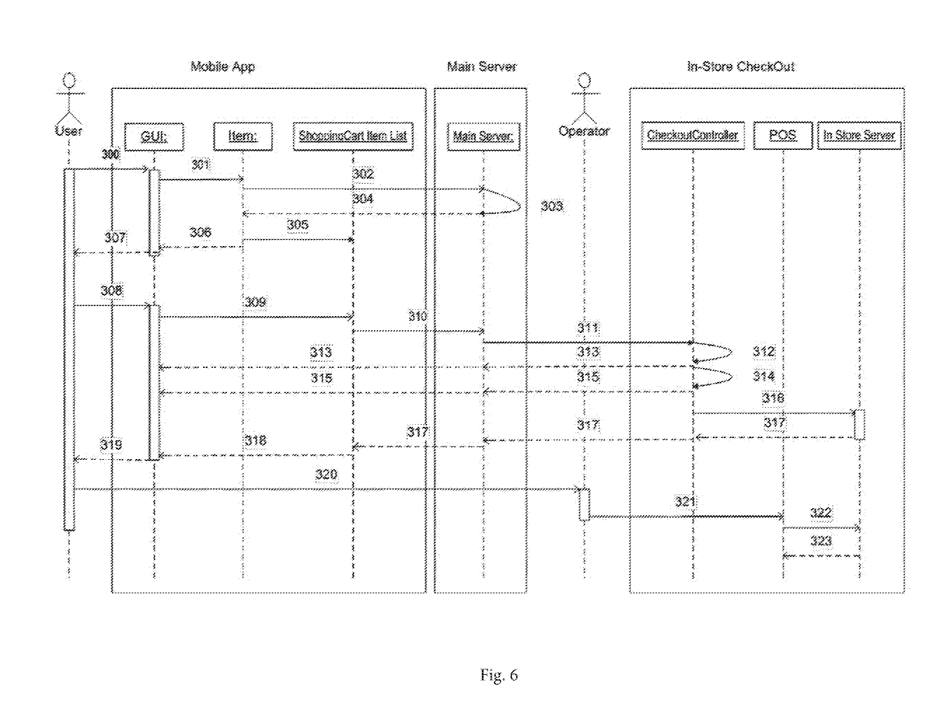

FIG. 6 shows an embodiment for the controller being connected to an in-store server which makes available barcode data for retrieval by the POS on submission of a token, e.g. short numeric code, by the operator when the token is received through the user mobile application, comprising the following actions/events by the respective parties as shown in the figure: user opens mobile app to start shopping 300, user reads the barcode from item with the mobile app 301, barcode is sent to the main server to get the product properties 302, main server decodes the barcode, retrieving info from the database 303, item properties are replied by the main server 304, item is added to the shopping cart item list 305, confirmation of item is on the shopping cart list 306, process is complete and user can add more items 307, the user starts the checkout process of the items list 308, command to checkout shopping cart is sent 309, shopping list cart is submitted to the main server 310, shopping list cart is sent by main server to in-store controller 311, automated check of the items on the list 312, automated check ok 313, human audit control of the items 314, human audit is ok 315, an In-Store sale transaction is created in the local server by the checkout controller 316, the transaction code is sent back to be displayed on the mobile app 317, the transaction code is displayed on the user display 318, user sees the code 319, the user tells the transaction code to the in-store operator 320, the operator inputs the transaction code in the POS system 321, POS systems pulls the sale transaction from the in-store server 322, sale transaction is processed on the POS system 323.

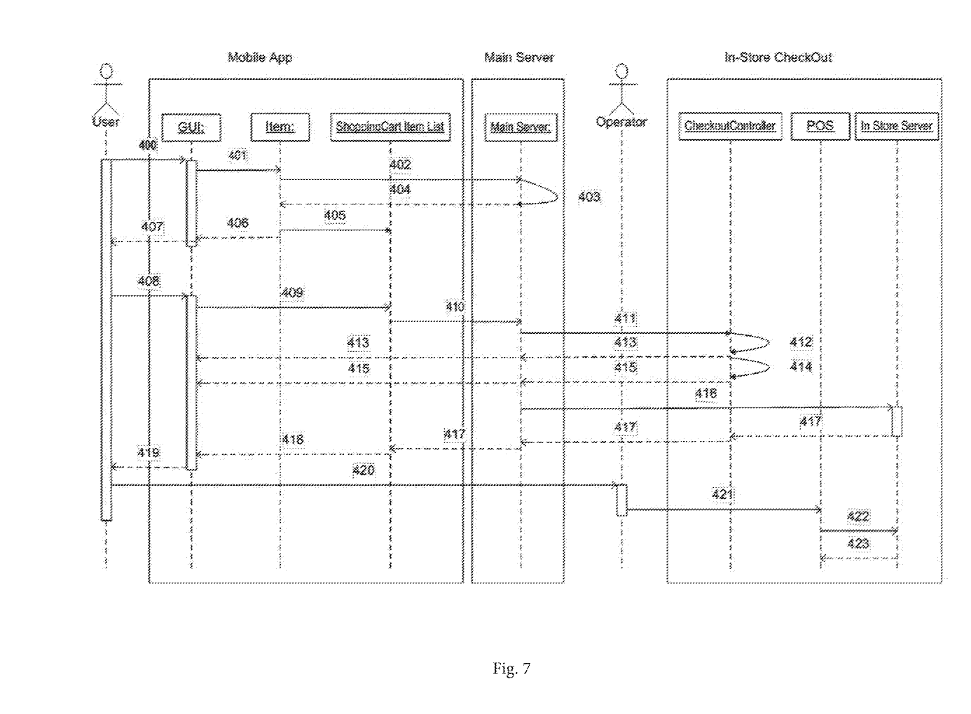

FIG. 7 shows an embodiment for the disclosed server being connected to an in-store server which makes available barcode data for retrieval by the POS on submission of a token, e.g. short numeric code, by the operator when the token is received through the user mobile application, comprising the following actions/events by the respective parties as shown in the figure: user opens mobile app to start shopping 400, user reads the barcode from item with the mobile app 401, barcode is sent to Main server to get the product properties 402, main server decodes the barcode, retrieving info from the database 403, item properties are replied by the main server 404, item is added to the shopping cart item list 405, confirmation of item is on the shopping cart list 406, process is complete and user can add more items 407, the user starts the checkout process of the items list 408, command to checkout shopping cart is sent 409, shopping list cart is submitted to the main server 410, shopping list cart is sent by main server to in-store controller 411, automated check of the items on the list 412, automated check is ok 413, human audit control of the items is triggered 414, human audit is ok 415, a In-Store shopping cart transaction is created in the in-store server by the main server 416, the transaction code is sent back to be displayed on the mobile app 417, the transaction code is displayed on the user display 418, user sees the code 419, the user tells the transaction code to the in-store operator 420, the operator inserts the code in the POS system to pull the sale transaction 421, POS systems pulls the sale transaction from the in-store server 422, sale transaction is processed on the POS system 423.

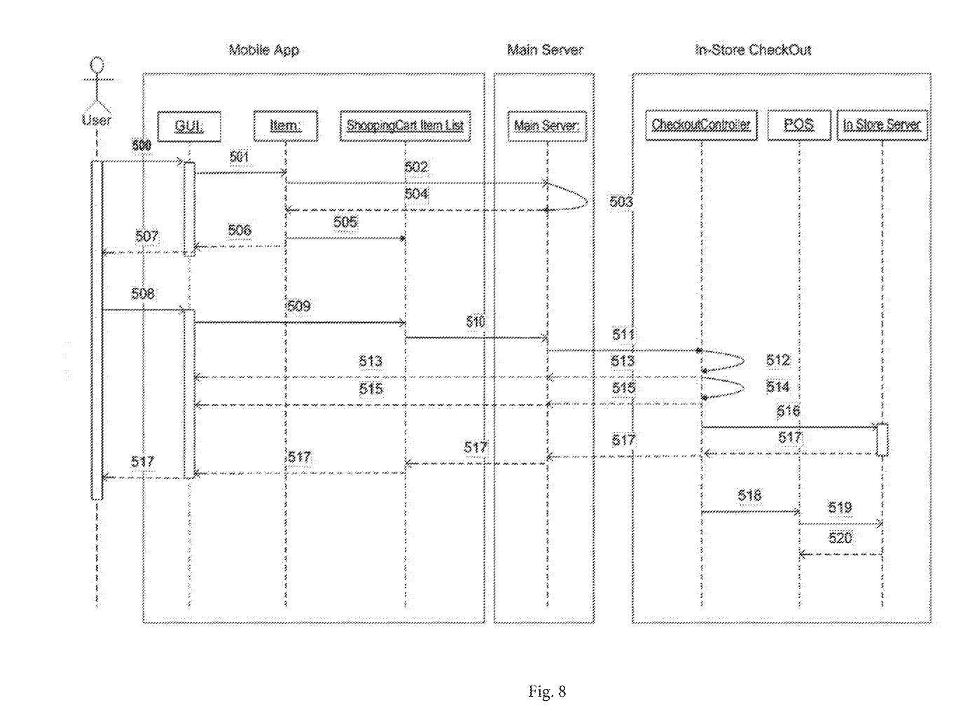

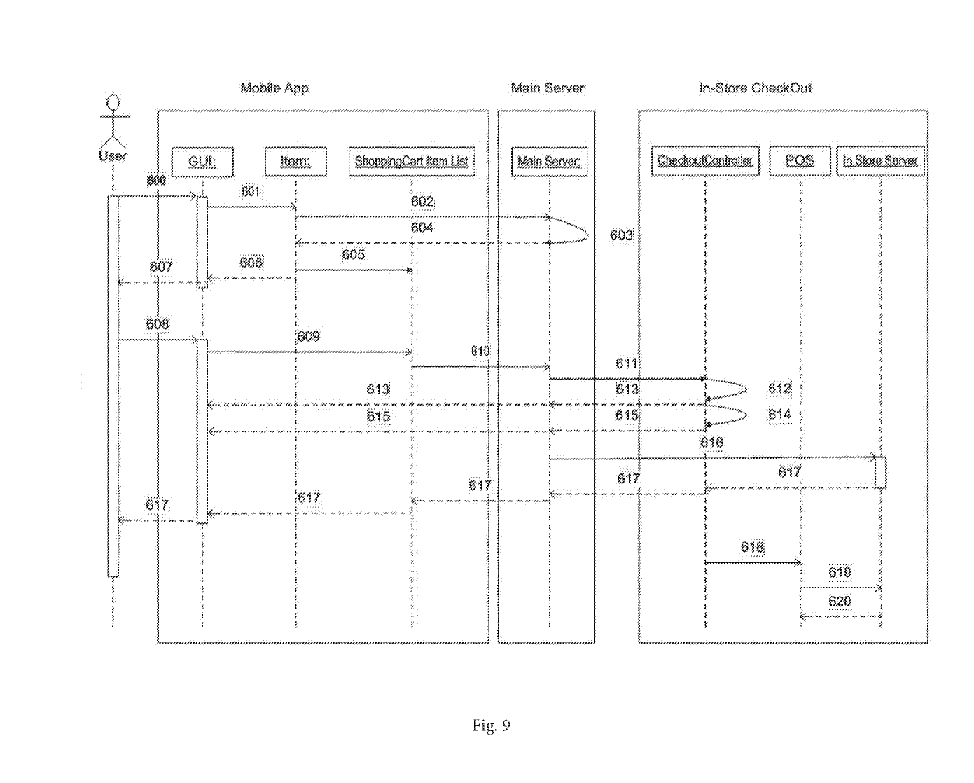

FIG. 8 shows an embodiment for the controller being connected to an in-store server which makes available barcode data for retrieval by the POS on submission of a token, e.g. short numeric code, by the controller directly to the POS device, comprising the following actions/events by the respective parties as shown in the figure: user opens mobile app to start shopping 500, user reads the barcode from item with the mobile app 501, barcode is sent to Main server to get the product properties 502, main server decodes the barcode, retrieving info from the database 503, item properties are replied by the main server 504, item is added to the shopping cart item list 505, confirmation of item is on the shopping cart list 506, process is complete and user can add more items 507, the User starts the checkout process of the items list 508, command to checkout shopping cart is sent 509, shopping list cart is submitted to the main server 510, shopping list cart is sent by main server to in-store controller 511, automated check of the items on the list 512, automated check is ok 513, human audit control of the items 514, human audit ok 515, a shopping cart transaction with all the items is created in the local in-store server by the Checkout controller 516, the user is informed about the operation success 517, the checkout controller inserts the transaction code in the POS systems 518, POS systems pulls the sale transaction from the in-store server 519, safe transaction is processed on the POS system 520.

FIG. 9 shows an embodiment for the disclosed server being connected to on in-store server which makes available barcode data for retrieval by the POS on submission of a token, e.g. short numeric code, by the controller directly to the POS device, comprising the following actions/events by the respective parties as shown in the figure: user opens mobile app to start shopping 600, user reads the barcode from item with the mobile app 601, barcode is sent to Main server to get the product properties 602, main server decodes the barcode, retrieving info from the database 603, item properties are replied by the main server 604, item is added to the shopping cart item list 605, confirmation of item is on the shopping cart list 606, process is complete and user can add more items 607, the User starts the checkout process of the items list 608, command to checkout shopping cart is sent 609, shopping list cart is submitted to the main server 610, shopping list cart is sent by main server to in store controller 611, automated check of the items on the list 612, automated check is ok 613, human audit control of the items 614, human audit is ok 615, a shopping cart transaction with all the items is created in the local in store server by the Main server 616, the user is informed about the operation success 617, the checkout controller inserts the transaction code in the POS systems 618, POS systems pulls the sale transaction from the in store server 619, a sale transaction is processed on the POS system 620.

A barcode may be understood as any automatic product ID technology suitable for identifying products at a retail location, in particular 20 barcodes such as EAN or UPC, 30 barcodes such as QR-codes, RFID-readable codes or even computer-identifiable product images.

The checkout controller is a device that interfaces with the existing POS, with the objective of mimicking operations that otherwise would be carried out by the operator, including, but not limited to manual input of product barcodes, allowing for full automation of the checkout process.

The unit can of course be implemented with a processor and/or other processor means, which can include one or more microprocessors, integrated circuits, FPGA's, optical processor's, etc. Typically an x86 or ARM based processor, running a Linux based operating system, with internal memory e.g. 256 MB generally SDRAM, and a non-volatile memory, e.g. SD card with 4 GB or solid state hard disk, with Ethernet or wireless communication to interact with the main server. The controller can have a video/audio controller that can be used to interact with the operator or user through an external display.

The checkout controller has a unique identifier code as to be identified by the Main server. The checkout is a client from the main server, typically over xmpp/html protocols.

The main server can be implemented with a processor and/or other processor means, which can include one or more microprocessors, typically a computer x86 based system that controls all the system components. Implemented as a Linux based server, running a web server (e.g. Apache or nginx), a database server (RD8MS or NoSQL) (e.g. PostgreSQL, MySQL or CouchBase), a XMPP Server (e.g. eJabberd) and cache management systems (e.g. MemCached)

The main server provides services by means of Service Oriented Architecture, like price check, shopping list management, logging, or transactions related to shopping and checkout operations.

Communications can be preferably carried out over HTTP/HTTPS or XMPP protocols, after successful security exchange and authentication.

The weight scale platform, physically has the minimum size required to hold a shopping basket, or any kind of container used for shopping, to be placed on the floor or over some kind of structure or furniture. The weight controller, may have or not, an internal central unit, with one or more processors, which can be used to acquire and process one or more load cells, typically of aluminium or stainless steel, with a load rating ranging from 0 to 400 kg. The structure, typically made of steel or stainless steel, can have multiple supporting points on the floor, intending to measure the total or partial part of the goods over it. The weight scale communicates with the checkout controller over a data communications layer, implemented over USB, Serial or Network.

The present disclosure includes preferably a mobile application, normally supported on all major mobile devices, typically native (e.g. Android, iphone (tOS) or Windows) or by using some kind of framework platforms like PhoneGap or Titanium, that provides the user with the possibility of managing coupons and promotions, and the possibility of checking-out the items contained in the shopping cart or other container used for shopping, collected and scanned using the mobile device's camera, or by the user, or by other automated mechanisms integrated on the mobile app.

Through the insertion of the checkout unit code by hand or other automated mechanism in the mobile app, the checkout process can be initiated and all the items on the shopping basket will be sent to the checkout controller for input on the POS.

A server, based on a computer that stores the complete catalogue of products sold, and provides through service-oriented architectures, means for decoding a product based on its barcode, or determining the sell price for that item.

By POS system is usually meant in the art the system present at each point of sale, i.e. the retail store computer responsible for processing the sale and e.g. printing the invoice. Point of sale is the point at which a customer makes a payment to the merchant in exchange for goods or services.

The above modules and methods can of course be implemented via software, firmware, and/or hardware, such as a processor and/or processor means, which can include one or more microprocessors, integrated circuits, FPGA's, optical processor's, etc.

The provision of one or more of the mentioned data transformation steps can be advantageously provided by procedural or transactional request messages.

Optionally, these procedural or transactional request messages may incorporate the decision steps conditional to the execution of said adjustment steps.

The term “comprising” whenever used in this document is intended to indicate the presence of stated features, integers, steps, components, but not to preclude the presence or addition of one or more other features, integers, steps, components or groups thereof.

Flow diagrams of particular embodiments of the presently disclosed methods are depicted in figures. The flow diagrams do not depict any particular means, rather the flow diagrams illustrate the functional information one of ordinary skill in the art requires to perform said methods required in accordance with the present disclosure.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order for the intended purpose.

The disclosure is of course not in any way restricted to the embodiments described and a person with ordinary skill in the art will foresee many possibilities to modifications thereof without departing from the basic idea of the disclosure as defined in the appended claims.

The above described embodiments are obviously combinable.

The following dependent claims set out particular embodiments of the disclosure.

1. Method of operating a system for processing retail purchases at a point-of-sale POS system, by a user carrying a personal mobile terminal, said mobile terminal having a network data connection and a barcode reader for reading, by the user, of the barcodes of the products to be purchased, said method comprising the steps of:
the mobile terminal reading the barcodes of the products to be purchased;
the mobile terminal sending the read barcodes to a computer server through said network data connection, wherein the computer server is remote from the mobile terminal and the POS system; and
said computer server sending the received barcodes to an electronic controller through a suitable data link, and
said controller sending, through a data connection to the POS system, the received barcodes to be processed by said POS system as a retail purchase by said user,
wherein the data connection between the controller and the POS system is a keyboard or barcode scanner connection emulated by said controller, and
wherein, prior to the retail purchase to be processed, said computer server and said mobile terminal have been mutually authorized and associated and said POS system and said mobile terminal are not configured to be mutually authorized and associated.

2. (canceled)

3. Method according to claim 1 further comprising the steps of:
the in-store server generating a unique token code identifying the received barcodes;
the in-store server transmitting said token code through said computer server and said mobile
terminal to the user,
such that said user may supply the POS system operator with said token code, and such that said POS system operator may supply said token code to the POS system;
the POS system using said token code for retrieving the received barcodes from said in-store server to be processed by said POS system as a retail purchase by said user.

4. Method according to claim 1 further comprising the steps of:
a in-store server generating a unique token code identifying the received barcodes;
the in-store server transmitting said token code to said controller,
the controller sending the token code to the POS system;
the POS system using said token code for retrieving the received barcodes from said in-store server to be processed by said POS system as a retail purchase by said user.

5. Method according to claim 1 further comprising the steps of:
said computer server sending, to the electronic controller, information on the products to be purchased for auditing purposes based on the received barcodes by said computer server;
said controller displaying said audit information about the products to be purchased and only proceeding with the retail purchase process if human confirmation of said audit information is received.

6. Method according to claim 1 further comprising the steps of:
said computer server sending, to the electronic controller, information on the products to be purchased for automatic verification purposes based on the received barcodes by said computer server, in particular the weight of the products corresponding to said barcodes;
said controller automatically verifying said automatic verification information about the products to be purchased, in particular by weighing the products to be purchased, and only proceeding with the retail purchase process if automatic confirmation of said verification information is obtained.

7. Non-transitory storage media including program instructions for implementing a system for processing retail purchases at a point-of-sale POS system, the program instructions including instructions executable to perform operations comprising:
the mobile terminal reading the barcodes of the products to be purchased;
the mobile terminal sending the read barcodes to a computer server through said network data connection, wherein the computer server is remote from the mobile terminal and the POS system; and
said computer server sending the received barcodes to an electronic controller through a suitable data link, and
said controller sending, through a data connection to the POS system, the received barcodes to be processed by said POS system as a retail purchase by said user
wherein the data connection between the controller and the POS system is a keyboard or barcode scanner connection emulated by said controller, and
wherein, prior to the retail purchase to be processed, said computer server and said mobile terminal have been mutually authorized and associated and said POS system and said mobile terminal are not configured to be mutually authorized and associated.

8. System for processing retail purchases at a point-of-sale POS system, by a user carrying a personal mobile terminal, said mobile terminal having a network data connection and a barcode reader for reading, by the user, of the barcodes of the products to be purchased, said system comprising:
a computer server for receiving the barcodes read by said mobile terminal through said network data connection, wherein the computer server is remote from the mobile terminal and
the POS system;
an electronic controller for receiving the barcodes received by said computer server through a suitable data link;
a data connection between said controller and said POS system that is a keyboard or barcode scanner connection emulated by said controller;
wherein said controller is arranged to emulate the received barcodes and to send to the POS system through said data connection the emulated received barcodes to be processed by said POS system as a retail purchase by said user, and
wherein, prior to the retail purchase to be processed, said computer server and said mobile terminal have been mutually authorized and associated and said POS system and said mobile terminal are not configured to be mutually authorized and associated.

9. System according to claim 8 wherein said data connection between the controller and the POS system is a keyboard or barcode scanner connection emulated by said controller.

10. System according to claim 8 comprising a plurality of said controllers and said data connections, wherein one controller is connected by a data connection to one and only one POS system, and wherein the mobile terminal is configured to identify the specific controller and respective POS system by scanning a barcode or other visual representation suitable for identification of a specific controller.

11. System according to claim 8 further comprising a weighing scale for weighing the products to be purchased and any carrying container of said products, said weighing scale being connected to the controller.

12. System according to claim 11 wherein the controller is configured to verify if the weight output by the weighing scale is lower than the total of:
the weight of products to be purchased identified by the received barcodes, plus
the weight of the empty carrying container or containers, plus
the weight of a predetermined tolerance,
in order to validate said retail purchase.

13. System according to claim 12 wherein the controller is configured to trigger a warning sign and halt the processing of the retail purchase if a container is not detected at the weighing scale or if the measured weight is outside by a predetermined tolerance of the weight of products to be purchased identified by the received barcodes, plus the weight of the empty carrying container or containers.

14. System according to claim 8 wherein the barcodes received by the controller from the server are sent by the server in a batch and the barcodes sent by the controller to the POS are sent in a batch, both said batches consisting of the totality of the barcodes of the products being purchased in said retail purchase.

15. System according to claim 8 wherein the controller comprises a human input and output interface for an operator and is arranged to display auditing information and to request a positive auditing confirmation by said operator in order to send the received barcodes to the POS system.

16. (canceled)

17. System according to claim 8 wherein the mobile terminal is a mobile phone or tablet comprising non-transitory storage media with a program for implementing said mobile terminal, and wherein the electronic controller comprises non-transitory storage media with a program for implementing said electronic controller, and wherein the server comprises non-transitory storage media with a program for implementing said server,
wherein the instructions of said programs include instructions executable to perform operations comprising:
the mobile terminal reading the barcodes of the products to be purchased;
the mobile terminal sending the read barcodes to a computer server through said network data connection; and
said computer server sending the received barcodes to an electronic controller through a suitable data link, and
said controller sending, through a data connection to the POS system, the received barcodes to be processed by said POS system as a retail purchase by said user; or
said computer server sending the received barcodes to be stored by an in-store POS server through a suitable data link, and
said POS system retrieving the received barcodes from said in-store POS server to be processed by said POS system as a retail purchase by said user.

18. System according to claim 9 wherein the mobile terminal is a mobile phone or tablet comprising non-transitory storage media with a program for implementing said mobile terminal, and wherein the electronic controller comprises non-transitory storage media with a program for implementing said electronic controller, and wherein the server comprises non-transitory storage media with a program for implementing said server,
wherein the instructions of said programs include instructions executable to perform operations comprising:
the mobile terminal reading the barcodes of the products to be purchased;
the mobile terminal sending the read barcodes to a computer server through said network data connection; and
said computer server sending the received barcodes to an electronic controller through a suitable data link, and
said controller sending, through a data connection to the POS system, the received barcodes to be processed by said POS system as a retail purchase by said user; or
said computer server sending the received barcodes to be stored by an in-store POS server through a suitable data link, and
said POS system retrieving the received barcodes from said in-store POS server to be processed by said POS system as a retail purchase by said user.

19. System according to claim 10 wherein the mobile terminal is a mobile phone or tablet comprising non-transitory storage media with a program for implementing said mobile terminal, and wherein the electronic controller comprises non-transitory storage media with a program for implementing said electronic controller, and wherein the server comprises non-transitory storage media with a program for implementing said server,
wherein the instructions of said programs include instructions executable to perform operations comprising:
the mobile terminal reading the barcodes of the products to be purchased;
the mobile terminal sending the read barcodes to a computer server through said network data connection; and
said computer server sending the received barcodes to an electronic controller through a suitable data link, and
said controller sending, through a data connection to the POS system, the received barcodes to be processed by said POS system as a retail purchase by said user; or
said computer server sending the received barcodes to be stored by an in-store POS server through a suitable data link, and
said POS system retrieving the received barcodes from said in-store POS server to be processed by said POS system as a retail purchase by said user.

20. The non-transitory storage media of claim 7, further comprising program instructions executable to perform the operations comprising:
the in-store server generating a unique token code identifying the received barcodes;
the in-store server transmitting said token code through said computer server and said mobile terminal to the user, such that said user may supply the POS system operator with said token code, and such that said POS system operator may supply said token code to the POS system; and
the POS system using said token code for retrieving the received barcodes from said in-store server to be processed by said POS system as a retail purchase by said user.

21. The non-transitory storage media of claim 7, further comprising program instructions executable to perform the operations comprising:
a in-store server generating a unique token code identifying the received barcodes;
the in-store server transmitting said token code to said controller;
the controller sending the token code to the POS system; and
the POS system using said token code for retrieving the received barcodes from said in-store server to be processed by said POS system as a retail purchase by said user.
